(19) United States
(12) Patent Application Publication
(10) Pub. No.: US 2017/0358246 A1
(43) Pub. Date: Dec. 14, 2017

(54) LEARNING APPLICATION CONTROLLING METHOD AND SYSTEM USING THE SAME

(71) Applicant: SMATOOS INC., Seoul (KR)

(72) Inventor: Moonsoo KIM, Seoul (KR)

(73) Assignee: SMATOOS INC., Seoul (KR)

(21) Appl. No.: 15/268,559

(22) Filed: Sep. 17, 2016

(30) Foreign Application Priority Data
Jun. 8, 2016 (KR) 10-2016-0071266

(51) Int. Cl. G09B 19/06; G09B 5/12; G09B 5/02

(52) U.S. Cl. CPC G09B 19/06; G09B 5/02; G09B 5/125

(57) ABSTRACT

A method for providing points obtained through a learning application as cash available in real life, a learning application controlling method includes: managing a point history to store point information that calculates points, which are obtained by performing a predetermined process provided from the learning application by each user account and/or transmit the point information to a server device; obtaining cash information assigned to a predetermined number of user accounts in a descending point acquisition order of total points based on the point information that the server device obtains from a plurality of terminals, from the server device; obtaining conversion point information on cash to be withdrawn in cash assigned to the user account based on the cash information; obtaining a withdrawal means for the withdrawal and payment information; and transmitting payment request information based on the conversion point information, the withdrawal means, and the payment information.

### CROSS-REFERENCE TO RELATED PATENT APPLICATION

This application claims the benefit of Korean Patent Application No. 10-2016-0071266 filed on Jun. 8, 2016 in the Korean Intellectual Property Office, the disclosure of which is incorporated herein in its entirety by reference.

### BACKGROUND OF THE INVENTION

### 1. Field of the Invention

The present invention relates to a method of operating a learning application for withdrawing points therefrom and a system using the same.

### 2. Description of the Related Art

Recently, the demand on a program for providing services to users to learn languages, technologies, and knowledge is increased. According to this demand, internet lectures using PCs are provided conventionally, and as tablets and smartphones are supplied, portable electronic devices provide such learning programs.

Such programs have advantages that users learn conveniently at a desired time but also have disadvantages that it is difficult for users to achieve seamless learning by forcing them or giving a sense of accomplishment to them.

### SUMMARY OF THE INVENTION

The present invention provides a method for operating a learning application to provide learning motivation by withdrawing points obtained through the learning application as money available in real life and a system using the same.

The technical objects of the present invention are not limited to those described above, and it will be apparent to those of ordinary skill in the art from the following description that the present invention includes other technical objects not specifically mentioned herein.

According to one aspect of the present invention, as a method for providing points obtained through a learning application as cash available in real life, a learning application controlling method includes: managing a point history to store point information that calculates points, which are obtained by performing a predetermined process provided from the learning application by each user account and/or transmit the point information to a server device; obtaining cash information assigned to a predetermined number of user accounts in a descending point acquisition order of total points based on the point information that the server device obtains from a plurality of terminals, from the server device; obtaining conversion point information on cash to be withdrawn in cash assigned to the user account based on the cash information; obtaining a withdrawal means for the withdrawal and payment information; and transmitting payment request information based on the conversion point information, the withdrawal means, and the payment information.

According to another aspect of the present invention, provided is a non-transitory recording medium where a program for performing the method is recorded.

### BRIEF DESCRIPTION OF THE DRAWINGS

The above and other features and advantages of the present invention will become more apparent by describing in detail exemplary embodiments thereof with reference to the attached drawings in which:

FIG. 1 is an environmental diagram of a learning system according to an embodiment of the present invention;

FIG. 2 is a block diagram of a terminal according to an embodiment of the present invention;

FIG. 3 is a block diagram of a server device according to an embodiment of the present invention;

FIG. 4 is an exemplary view illustrating a login screen according to an embodiment of the present invention;

FIG. 5 is a flowchart illustrating an operating method of a learning game mode according to an embodiment of the present invention;

FIG. 6 is an exemplary view of a learning game GUI according to an embodiment of the present invention;

FIG. 7 is an exemplary view of a game step layer according to an embodiment of the present invention;

FIG. 8 is an exemplary view of a learning game according to an embodiment of the present invention;

FIG. 9 is an exemplary view of a help request layer according to an embodiment of the present invention;

FIG. 10 is a flowchart illustrating an operation during a connection from a help request message according to an embodiment of the present invention;

FIG. 11 is an exemplary view of a vocabulary category according to an embodiment of the present invention;

FIG. 12 is an exemplary view of a vocabulary learning GUI according to an embodiment of the present invention;

FIG. 13 is an exemplary view of a vocabulary learning layer according to an embodiment of the present invention;

FIG. 14 is an exemplary view of a learning video according to an embodiment of the present invention;

FIG. 15 is an exemplary view of an example sentence learning according to an embodiment of the present invention;

FIG. 16 is a flowchart illustrating a reward function according to an embodiment of the present invention;

FIG. 17 is an exemplary view illustrating a conversion point calculation according to an embodiment of the present invention;

FIG. 18 is an exemplary view illustrating a paid service payment using cash according to an embodiment of the present invention; and

FIG. 19 is a view illustrating a lottery type cash obtaining method according to an embodiment of the present invention.

### DETAILED DESCRIPTION OF THE INVENTION

The objects, features, and advantages of the present invention become more apparent from the following detailed description with reference to the accompanying drawings. However, various modifications are possible in various embodiments of the present invention and thus, specific embodiments are illustrated in drawings and related detailed descriptions are listed.

In the accompanying drawings, the thicknesses of layers and areas are exaggerated for clarity and also, it will be understood that when an element or a layer is referred to as being “on” another element or layer, it may be directly on the other element or intervening elements may also be present. The same reference numerals denote the same elements in principle throughout the specification. Additionally, like reference numerals refer to like elements.

Additionally, detailed descriptions of well-known functions or configurations will be omitted since they would obscure the present invention in unnecessary detail. Additionally, numbers (for example, first and second) used in the description of this specification are just identification symbols for distinguishing one component from another component.

The suffixes “module” and “unit” for components used in the description below are assigned or mixed in consideration of easiness in writing the specification and do not have distinctive meanings or roles by themselves.

According to one aspect of the present invention, as a method for providing points obtained through a learning application as cash available in real life, a learning application controlling method includes: managing a point history to store point information that calculates points, which are obtained by performing a predetermined process provided from the learning application by each user account and/or transmit the point information to a server device; obtaining cash information assigned to a predetermined number of user accounts in a descending point acquisition order of total points based on the point information that the server device obtains from a plurality of terminals, from the server device; obtaining conversion point information on cash to be withdrawn in cash assigned to the user account based on the cash information; obtaining a withdrawal means for the withdrawal and payment information; and transmitting payment request information based on the conversion point information, the withdrawal means, and the payment information.

Additionally, the predetermined process may be at least one of a learning game mode, a vocabulary learning mode, and an advertisement playback.

Additionally, a learning game GUI may be provided in the learning game mode, and a plurality of learning game specific category objects may be provided to the learning game GUI.

Additionally, the learning game specific category object may be linked to a game step layer where a game step object for game steps belonging to the learning game category is provided.

Additionally, a game step object provided to a game step layer may be linked to a learning game corresponding to the game step.

Additionally, when a combination of a spelling of objects sequentially selected through a drag input and/or continuous touch matches a spelling of a predetermined word, the game may determine that a corresponding step is completed.

Additionally, when a help request object is provided and selected, the game may request a predetermined SNS to write a help request message based on an image on the game and a step of the game through the predetermined SNS.

Additionally, the vocabulary learning mode may be at least one of a first mode for providing a category specific word and a comment for the word, a second mode for playing a predetermined video; and a third mode for providing a predetermined example sentence.

Additionally, the managing of the point history may include calculating points provided according to a step completed in the learning game mode.

Additionally, the managing of the point history may include calculating points provided according to the number of playing the advertisement.

Additionally, the managing of the point history may include calculating points provided according to a step completed in the vocabulary learning mode.

According to another aspect of the present invention, provided is a non-transitory recording medium where a program for performing the method is recorded.

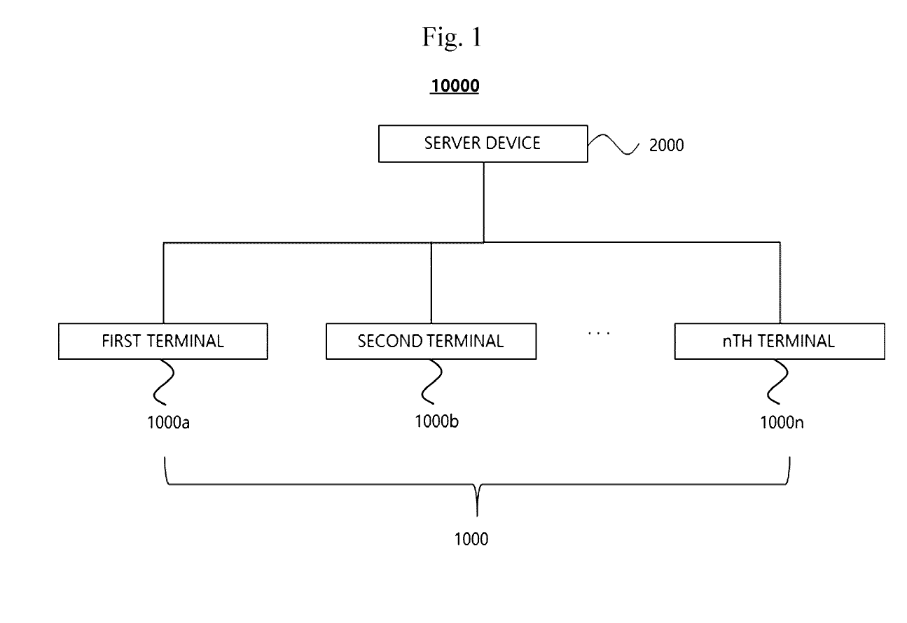

FIG. 1 is an environmental diagram of a learning system 10000 according to an embodiment of the present invention.

Referring to FIG. 1, the learning system 10000 may include a terminal 1000 and a server device 2000.

The terminal 1000 may be connected to the server device 2000.

The terminal 1000 may transmit data to the server device 2000.

For example, the terminal 1000 may transmit account information, progress information, payment information, and mileage information.

The server device 2000 may be connected to the terminal 1000.

The server device 2000 may be connected to a plurality of terminals 1000 as shown in FIG. 1.

The server device 2000 may obtain data from the plurality of terminals 1000. For example, the server device 2000 may obtain data such as learning progress and payment information.

Additionally, the server device 2000 may transmit data such as ranking information, friend information, and payment completion information to the plurality of terminals 1000.

The server device 200 may manage a history of data obtained from the plurality of terminals 1000.

For example, the server device 2000 may obtain progress information from the plurality of terminals 1000 and store a history of account specific progress.

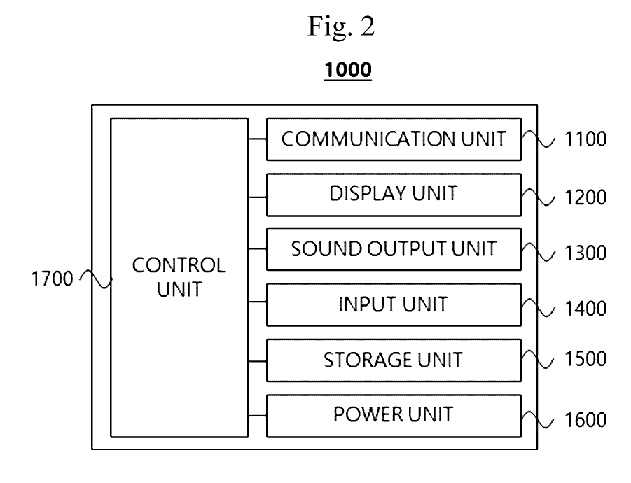

FIG. 2 is a block diagram of a terminal 1000 according to an embodiment of the present invention.

Referring to FIG. 2, the terminal 1000 may include a communication unit 1100, a display unit 1200, a sound output unit 1300, an input unit 1400, a storage unit 1500, a power unit 1600, and a control unit 1700.

The communication unit 1100 may transmit/receive data. For example, the communication unit 1100 may be connected to the server device 2000 to transmit/receive data. The communication unit 1100 may be connected to the server device 2000 in a wireless communication method and/or a wired communication method. For example, the communication unit 1100 may be connected to the server device 2000 in a wireless communication method such as WiFi, 3G, LTE, and 5G. As another example, the communication unit 1100 may be connected to the server device 2000 in a wired communication method such as LAN, serial communication, and parallel communication. For another example, the communication unit 1100 may be connected to the server device 2000 through a communication network provided from a communication service provider.

The display unit 1200 may output visual information.

For example, the display unit 1200 may output a graphical user interface (GUI) implemented by application or program.

The display unit 1200, for example, may be a display panel such as AMOLED display, LCD, PDP, and OLED.

Additionally, the display unit 1200 may further include a touch panel.

When the display unit 1200 includes a touch panel, it may obtain a signal corresponding to a user's touch and transmit the obtained signal to the control unit 1700.

The sound output unit 1300 may output auditory information.

For example, the sound output unit 1300 may output auditory information such as background music (B/GM), effect sound, and notification.

The sound output unit 1300, for example, may be implemented with a speaker, a buzzer, and a bell.

The input unit 1400 may obtain an electrical signal corresponding to a user's input.

The input unit 1400, for example, may be implemented with a keyboard, a mouse, a touch panel, a wheel, a jog shuttle, and a switch.

The storage unit 1500 may store data.

For example, the storage unit 1500 may store program and setting necessary for an operation of the terminal 1000. Additionally, the storage unit 1500 may store data generated according to an application operation. For example, the storage unit 1500 may store progress information, account information, and payment information, which are generated during an application operation. Additionally, the storage unit 1500 may store data obtained from an external electronic device. For example, the storage unit 1500 may store information obtained from the server device 2000.

The power unit 1600 may supply power necessary for an operation of the terminal 1000.

The power unit 1600, for example, may be implemented with a battery and a power supply, and as another example, may be implemented with a power module for receiving power from the outside or a charging module.

The control unit 1700 may manage overall operations of the terminal 1000.

For example, the control unit 1700 may control an operation for at least one configuration among configurations included in the terminal 1000.

Additionally, the control unit 1700 may control the execution of an application pre-stored in the terminal 1000.

The above-mentioned configuration of the terminal 1000 is just an example for convenience of description and is not limited to the above. According to a selection, the terminal 1000 including only part of the configuration of the terminal 1000 may be provided, and also the terminal 1000 including an additional configuration in addition to the configuration of the terminal 1000 may be provided. For example, when the display unit 1200 is provided including a touch panel, the input unit 1400 is not provided to the terminal 1000 and the display unit 1200 may serve a function of the input unit 1400 instead.

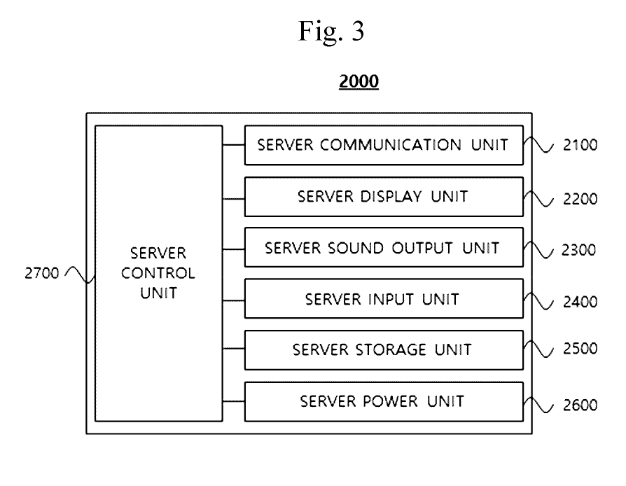

FIG. 3 is a block diagram of a server device 2000 according to an embodiment of the present invention.

Referring to FIG. 3, the server device 2000 may include a server communication unit 2100, a server display unit 2200, a server sound output unit 2300, a server input unit 2400, a server storage unit 2500, a server poser unit 2600, and a server control unit 2700.

The server communication unit 2100 may transmit/receive data. For example, the server communication unit 2100 may be connected to at least one terminal 1000 to transmit/receive data. The server communication unit 2100 may be connected to the terminal 1000 in a wireless communication method and/or a wired communication method. For example, the server communication unit 2100 may be connected to the terminal 1000 in a wireless communication method such as WiFi, 3G, LTE, and 5G. As another example, the server communication unit 2100 may be connected to the terminal 1000 in a wired communication method such as LAN, serial communication, and parallel communication. For another example, the server communication unit 2100 may be connected to the terminal 1000 through a communication network provided from a communication service provider.

The server display unit 2200 may output visual information.

For example, the display unit 2200 may output a user interface (UI) implemented by server program, application, and other programs.

The server display unit 2200, for example, may be a display panel such as AMOLED display, LCD, PDP, and OLED.

Additionally, the server display unit 2200 may further include a touch panel.

When the server display unit 2200 includes a touch panel, it may obtain a signal corresponding to a user's touch and transmit the obtained signal to the server control unit 2700.

The server sound output unit 2300 may output auditory information.

For example, the server sound output unit 2300 may output auditory information such as background music (BGM), effect sound, and notification.

The server sound output unit 2300, for example, may be implemented with a speaker, a buzzer, and a bell.

The server input unit 2400 may obtain an electrical signal corresponding to a user's input.

The server input unit 1400, for example, may be implemented with a keyboard, a mouse, a touch panel, a wheel, a jog shuttle, and a switch.

The server storage unit 1500 may store data.

For example, the server storage unit 1500 may store program and setting necessary for an operation of the server device 2000. Additionally, the server storage unit 1500 may store data obtained from an external electronic device. For example, the server storage unit 1500 may store information obtained from the terminal 1000.

The server power unit 1600 may supply power necessary for an operation of the server device 2000.

The server power unit 1600, for example, may be implemented with a battery and a power supply, and as another example, may be implemented with a power module for receiving power from the outside or a charging module.

The server control unit 2700 may manage overall operations of the server device 2000.

For example, the server control unit 2700 may control an operation for at least one configuration among configurations included in the terminal 2000.

Hereinafter, referring to the drawing, an operation of a learning application executed in the terminal 1000 in the learning system 10000 according to an embodiment of the present invention will be described.

A user's selection described below may include a user input through click and touch.

1. Login

The control unit 1700 may control the display unit 1200 to output a login GUI.

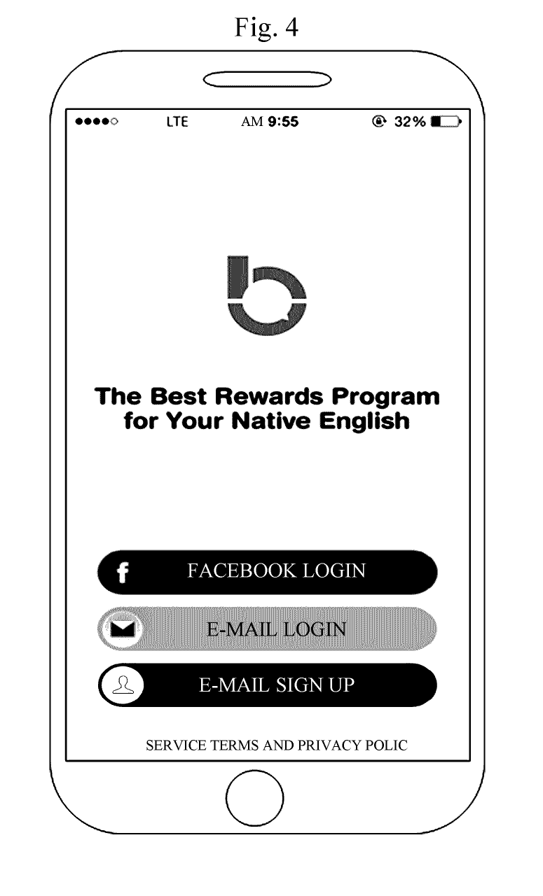

FIG. 4 is a view illustrating a login screen according to an embodiment of the present invention.

An object for at least one login method may be provided to the GUI of the login screen.

For example, as shown in FIG. 4, an object connected in a login method using e-mail, an object connected in a login method linked with a specific social network, and an object connected using account registration may be provided.

Additionally, an object for allowing an unregistered user to be joined as a member may be provided to the GUI of the login screen.

2. Learning Game Mode

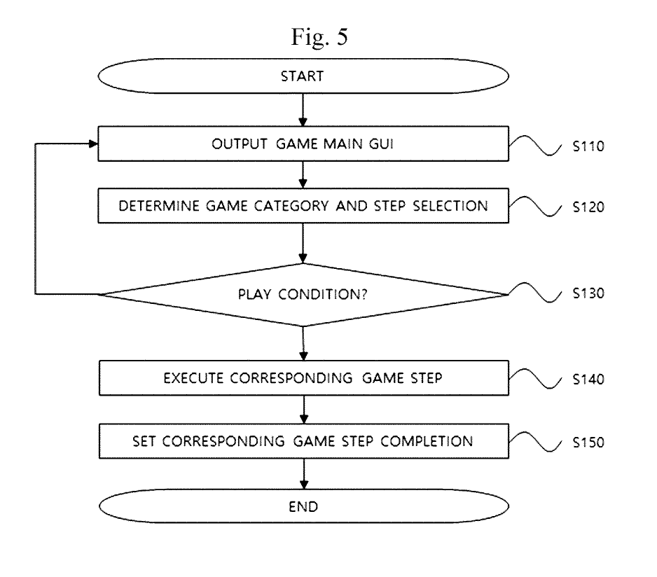

FIG. 5 is a flowchart illustrating an operating method of a learning game mode according to an embodiment of the present invention.

Referring to FIG. 5, the operating method of the learning game mode may include outputting a learning game main GUI (operation S110), determining a game category and stop selection (operation S120), determining a play condition (operation S130), executing a corresponding game step (operation S140), and setting the completion of a corresponding game step (operation S150).

The control unit 1700 may control a learning game main GUI to be outputted.

The control unit 1700 may control the display unit 1400 to output an object linked to a category specific learning game.

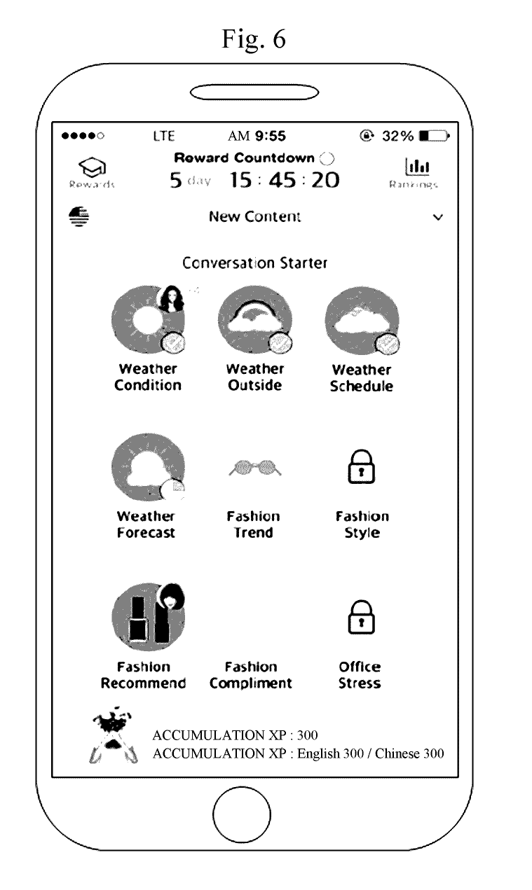

FIG. 6 is an exemplary view of a learning game GUI according to an embodiment of the present invention.

For example, as shown in FIG. 6, a game category object linked to a learning game preset to each classified category such as weather condition, weather outside, and weather schedule may be outputted to the learning game GUI.

The control unit 1700 may determine a game category and step selection in operation S120.

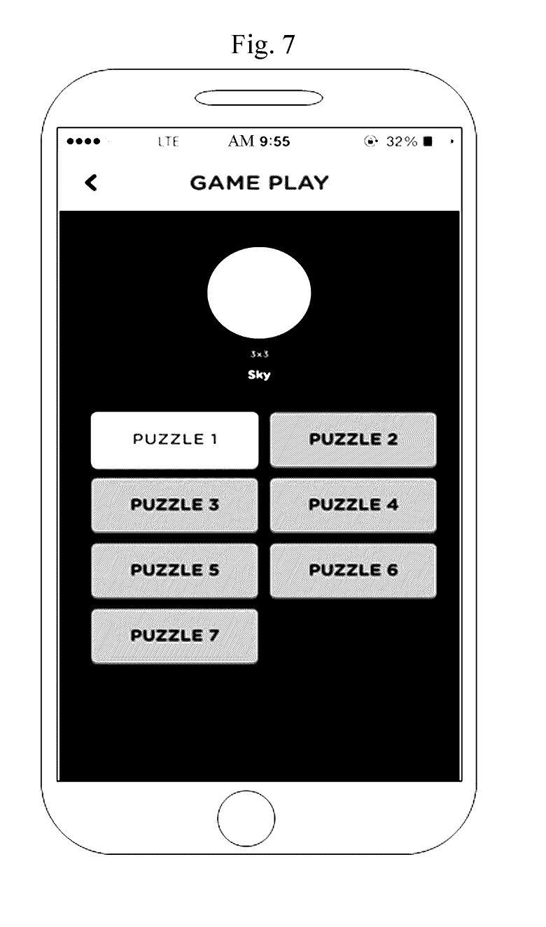

FIG. 7 is an exemplary view of a game step layer according to an embodiment of the present invention.

When a user selects a game category object outputted to a learning game GUI, for example, as shown in FIG. 7, the control unit 1700 may perform a control to provide a game step layer where a list of learning game levels linked to the selected game category object is provided. Additionally, when at least one game level is selected from the game level list, the control unit 1700 may control a learning game corresponding to the selected game level to be executed.

The control unit 1700 may determine a play condition in operation S130.

Some of the plurality of game category objects and/or game levels may be disconnected from a learning game. For example, even when a user's selection is inputted, some of game category objects and/or levels may not be connected to a corresponding game and a message for notifying connection unavailability may be outputted according to a predetermined condition.

For a more specific example, the execution condition of a game may be determined according to the amount of tickets for limiting the number of game executions.

For example, when the number of tickets provided to a user account is less than the number of tickets necessary for game execution, the control unit 1700 may control learning game execution to be unavailable.

For another example, when it is set in a user account that a previous step learning game is not completed, the control unit 1700 may control learning game execution to be unavailable.

The control unit 1700 may control a game step to be executed in operation S140.

When a predetermined condition is satisfied, the control unit 1700 may control a game step to be executed.

The learning game may provide various types of games.

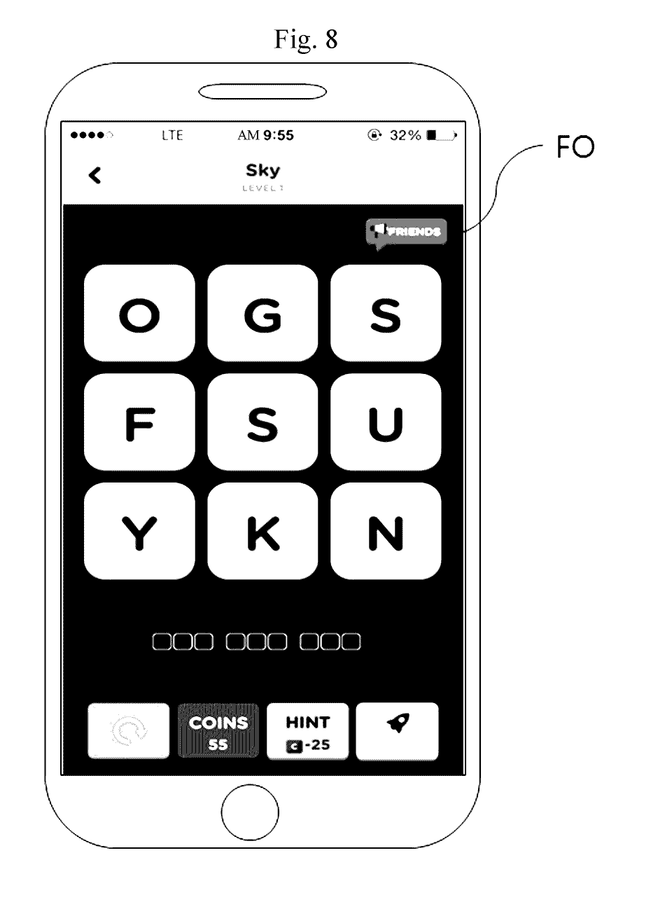

FIG. 8 is an exemplary view of a learning game according to an embodiment of the present invention.

For example, as shown in FIG. 8, the learning game may provide a plurality of objects where a spelling is displayed randomly, and when a combination of the spelling of objects selected sequentially through a user's drag input and/or continuous touch corresponds to the spelling of a predetermined word, a game that determines that a corresponding step is completed may be provided. The spelling of a predetermined word in such each step may be provided in plurality. For example, the control unit 1700 may determine that a corresponding step is completed when a spelling for each of two words assigned to a first step is identical to each other.

A game area where a game is outputted and a game object area where a plurality of objects are outputted may be provided to the GUI of the learning game.

Additionally, as shown in FIG. 8, a game in the current step may be outputted to the game area of the learning game and a game object area where a plurality of objects added to a game process may be provided.

A help request object FO may be provided to the learning game.

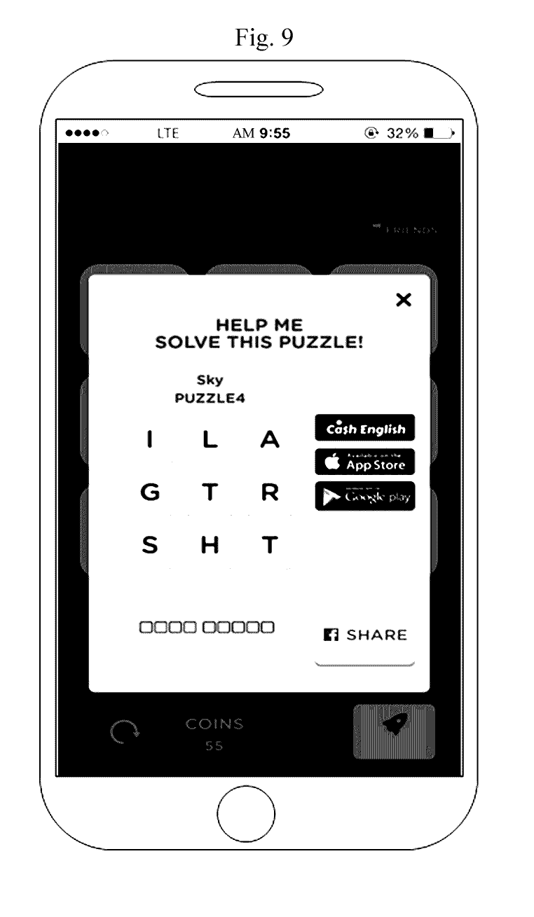

FIG. 9 is an exemplary view of a help request layer according to an embodiment of the present invention.

When the help request object FO is selected, the control unit 1700 may perform a control to output a help request layer. An image for a game screen outputted to a game area may be provided to the help request layer. The control unit 1700 may obtain help request information including at least one of an image for a game screen, information on a learning game step, and a predetermined help sentence.

An object for selecting the final approval for a game screen, step information, and help request message writing may be provided to the help request layer for transmitting help information.

The control unit 1700 may perform a control to post a help request message based on the help request information on a predetermined SNS. Herein, an example of the predetermined SNS may be an SNS using ID when a user logs in or an SNS that a user inputs arbitrarily on a game setting. Moreover, an SNS may be replaced with a messenger service (for example, NAVER LINE, KakaoTalk, telegram, SMS or MMS). In this case, instead of posting a help request message on SNS, text or help image may be transmitted to a terminal of a user registered as a friend.

For example, the control unit 1700 may transmit help request information and a user's account on a predetermined SNS to a predetermined SNS server so as to write a help request message based on the help request information and post it. For another example, the control unit 1700 may transmit help request information and a user's account on a predetermined SNS to the server device 2000 and request the server device 2000 to transmit them to a predetermined SNS server. The server device 2000 may transmit help request information and a user's account to a predetermined SNS so as to request the posting of a help request message.

For another example, the control unit 1700 may access a predetermined SNS by using a pre-registered user's account so as to post a help request message on a predetermined SNS instead of a user.

When a learning application is executed in linkage with a help request message written by another user account, the control unit 1700 may control it to operate according to some conditions.

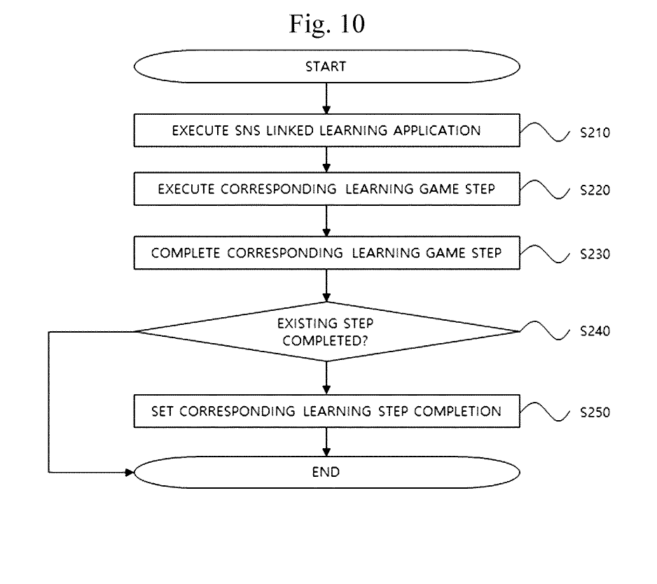

FIG. 10 is a flowchart illustrating an operation during a connection from a help request message according to an embodiment of the present invention.

Referring to FIG. 10, an operation during a connection from a help request message may include executing a learning application in linkage with SNS (operation S210), executing a corresponding learning game (operation S220), determining that a corresponding learning game step is completed (operation S230), determining whether the completed step is an existing completed step (operation S240), and setting the completion of the corresponding learning step (operation S250).

The control unit 1700 may control a learning application to be executed in linkage with SNS in operation S210.

For example, the control unit 1700 may obtain a message for request the execution of the learning application from an SNS where a help request message is written, and execute the learning application according to a request of SNS.

For another example, when it is determined that a predetermined area is selected from a help request message written on SNS, the control unit 1700 may control the learning application to be executed.

The control unit 1700 may execute a corresponding learning game step in operation S220.

The control unit 1700 may execute a corresponding learning game step based on step information included in a help request message.

For example, the control unit 1700 may execute a corresponding game step based on a help request message written on SNS.

For another example, the control unit 1700 may execute a corresponding game step based on step information from SNS.

The control unit 1700 may determine that a corresponding learning game step is completed in operation S230.

When the completion condition of a predetermined corresponding learning game step is satisfied, the control unit 1700 may determine that the corresponding learning game step is completed.

For example, when a combination of the spelling of objects sequentially selected through a user's drag input and/or continuous touch is identical to the spelling of a predetermined word, the control unit 1700 may determine that a corresponding step is completed.

The control unit 1700 may determine whether the completed step is an existing completed step in operation S240.

The control unit 1700 may determine whether the completed learning step after executed based on the help request message is set as the existing completed step on the basis of learning game step information pre-stored in linkage with a user account.

When the completed learning step is the existing completed step, the control unit 1700 may control a corresponding learning game to be terminated.

The control unit 1700 may set the corresponding learning step to be completed in operation S250.

When it is determined that the completed learning step is not the existing completed step, the control unit 1700 may set the corresponding step to be completed and store it in the learning game step information pre-stored in linkage with the user account.

3. Vocabulary Learning Mode

The control unit 1700 may control a vocabulary learning mode to be executed.

The control unit 1700 may perform a control to output a vocabulary learning GUI for vocabulary learning.

The control unit 1700 may perform a control to output a vocabulary category object for vocabulary learning.

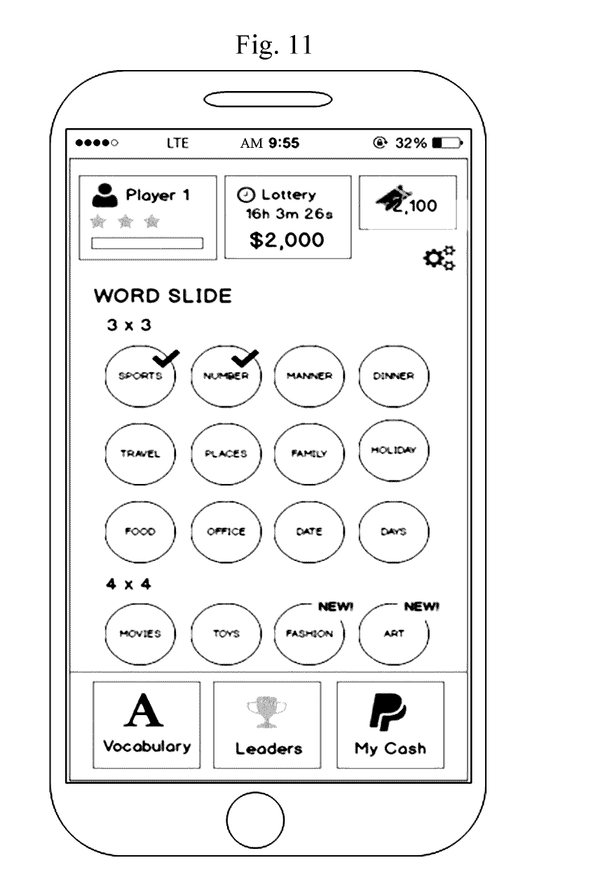

FIG. 11 is an exemplary view of a vocabulary category according to an embodiment of the present invention.

As shown in FIG. 11, a vocabulary category specific object may be provided to a vocabulary learning main GUI.

When a user selects a vocabulary category object outputted to the vocabulary learning main GUI, the control unit 1700 may control a vocabulary learning connected to the selected vocabulary category object to be executed.

The point may be given to the user account according to the result of performing the vocabulary learning. For example, the point may be given to the user account according to the number of performing the vocabulary learning. For another example, the point may be given to the user account according to the number of replaying the video learning. For still another example, the point may be given to the user account according to the sentence learning.

A vocabulary learning mode may be provided in various forms.

3-1. Vocabulary Learning

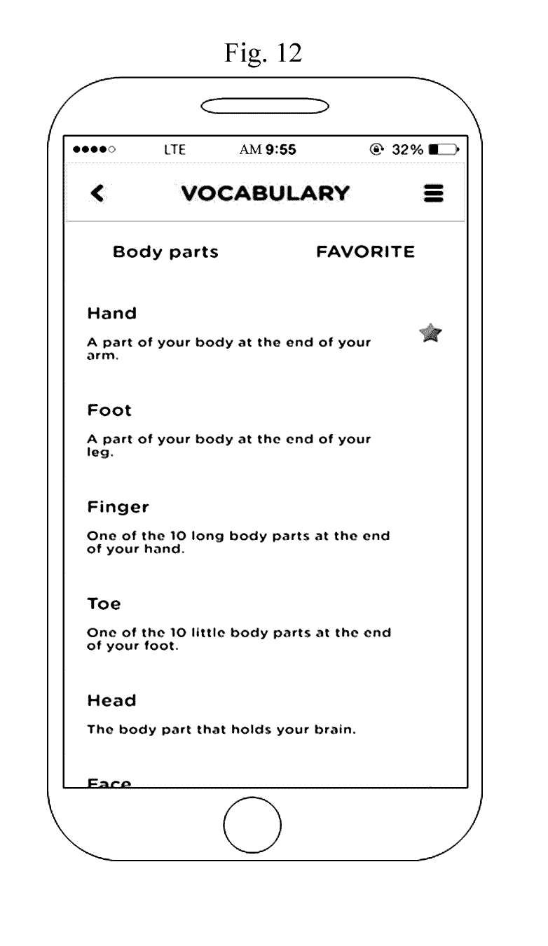

FIG. 12 is an exemplary view of a vocabulary learning GUI according to an embodiment of the present invention.

As shown in FIG. 12, a list of words belonging to a category may be outputted to a vocabulary learning GUI. Additionally, a commend for each word may be outputted to the vocabulary learning GUI.

The control unit 1700 may determine whether a user makes a selection on each word list.

When it is determined that a favorites object outputted to be overlapped in an area where one word is outputted is selected, the control unit 1700 may register a corresponding word in a favorites category. Accordingly, when the favorites category is selected, the control unit 1700 may control a list of words registered in the favorites category to be outputted.

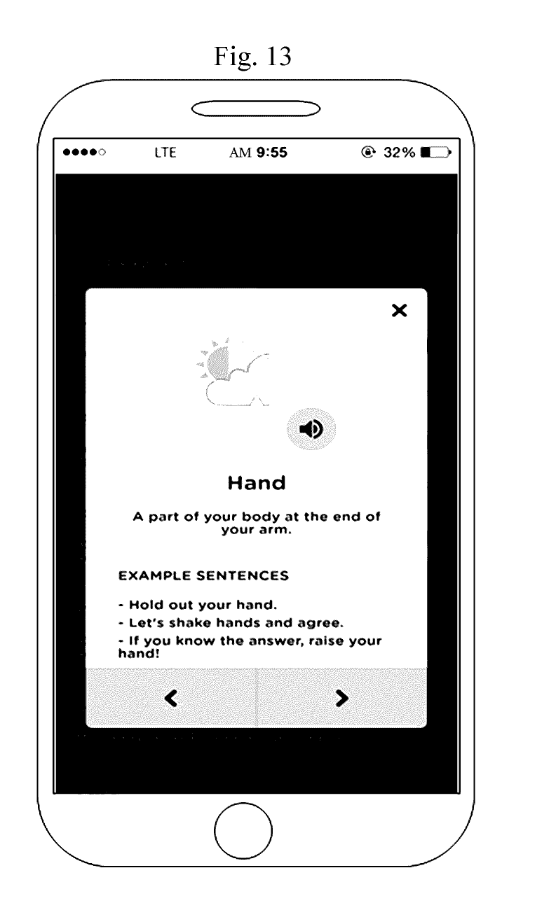

FIG. 13 is an exemplary view of a vocabulary learning layer according to an embodiment of the present invention.

When it is determined that another area where one word is outputted is selected, the control unit 1700 may perform a control to output a layer including at least one of an icon for selecting the playback of a sound (for example, a sound for the pronunciation of a corresponding word), which is matched to a selected word, an image for representing a word, a comment for a word, a related example sentence, and a word and stored, an icon for selecting the movement to a previous or next word, and an icon for selecting the termination of a detailed vocabulary learning.

3-2. Video Learning

The control unit 1700 may control a video learning mode to be executed.

The control unit 1700 may control a video learning main GUI to be outputted. A learning video-classified category specific object may be provided to the video learning main GUI.

The control unit 1700 may perform a control to output a list of learning videos belonging to the selected category.

The control unit 1700 may control a selected learning video to be played.

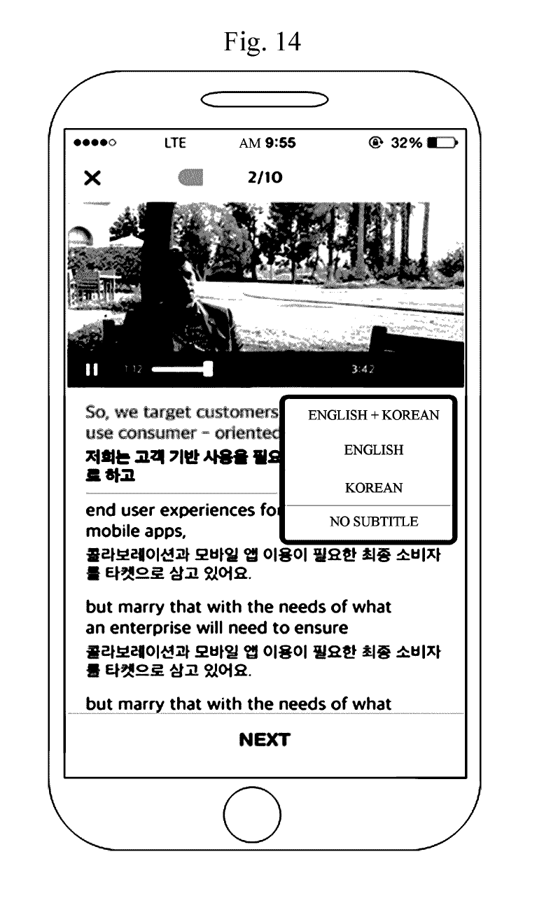

FIG. 14 is an exemplary view of a learning video according to an embodiment of the present invention.

As shown in FIG. 14, a learning video may be provided to one area (for example, a playback area) of a learning video layer. Additionally, an area for outputting a step in the current category may be provided to the learning video layer and at least part of a subtitle, which is matched to a learning video and stored, may be provided to a subtitle output area separated from an area where the learning video is played. Additionally, an object for receiving a selection on the movement to the next learning video and/or previous learning video may be provided.

Additionally, an object for receiving a selection on a language change of a subtitle may be provided to the learning video layer.

For example, when a subtitle language change object is selected, the control unit 1700 may perform a control to output a list for change available subtitle types and output a selected subtitle language to a subtitle output area.

Hereinafter, examples of obtaining the point related to the video learning will be described.

The obtaining the point related to the video learning described below may include giving the point to the user account who performs replaying the video learning. Herein, the giving operation may be performed by the terminal 1000 or the server 2000 which are logged by the user account.

Hereinafter, for convenience of description it is explained that the terminal 1000 gives the point to the user account and transmits the result of giving the point to the server 2000 as an example of the giving operation.

The terminal 1000 gives the point to the user account based on a replay time of the video learning, a replay percentage of the video learning, the number of the video learning replay and whether or not the iterative learning is performed.

For example, when one video for learning is replayed for one minute the terminal 1000 gives ten points, which corresponds to one minute, to the terminal 1000 logged by the user account.

For another example, when it is set that one hundred points correspond to the completion of one video for learning, ten point can be given to the user account who replayed ten percent of the video learning.

For still another example, the terminal 1000 gives the point according to the number of the video learning replay. For a more specific example, when it is set that a hundred points correspond to one replay, three hundred points is given to the user who replays the video for learning three times.

Furthermore, the terminal 1000 may perform a graded point-giving considering whether the replay is the first or not. For example, a hundred points may be given for the first replay and fifty points may be given for a replay after the first replay.

The terminal 1000 may give the point to the user account and transmit the result of the point-giving to the server 2000. For example, the terminal 1000 may transmit the information on the user account who acquires the point and the amount of the point given to the user account to the server 2000.

The present invention is not limited to the above-mentioned point-giving method, and the server 2000 may give the point to the user account by acquiring information on the replay of the video learning from the terminal 1000. The terminal 1000 may transmit the information on the user account to whom the point is given and the information on the replay of the video for learning. And the server 2000 may give the point to the user account based on the received information and transmit the result to the terminal 1000.

3-3. Example Sentence Learning

The control unit 1700 may control an example sentence learning mode to be executed.

The control unit 1700 may control an example sentence learning main GUI to be outputted. An example sentence learning layer-classified category specific object may be provided to the example sentence learning main GUI.

The control unit 1700 may perform a control to output a list of example sentence learning layers belonging to the selected category.

The control unit 1700 may perform a control to output a selected example sentence learning layer.

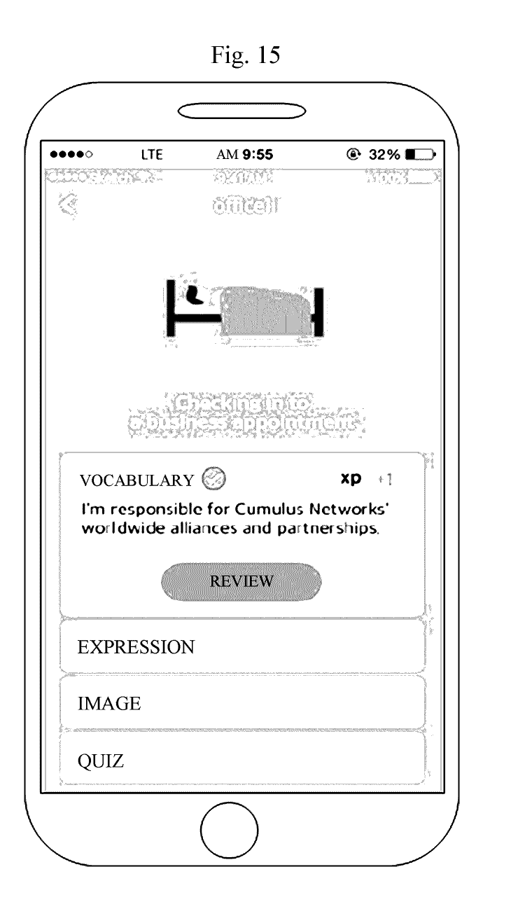

FIG. 15 is an exemplary view of an example sentence learning according to an embodiment of the present invention.

As shown in FIG. 15, an example sentence in the current step may be provided to one area (for example, an example sentence area) of an example sentence learning layer. Additionally, at least one of an icon linked to information on another expression relating to an example sentence, an icon linked to an image relating to an example sentence, and an icon linked to a quiz relating to an example sentence may be provided to the example sentence learning layer. Additionally, information on points obtained when learning on a sentence is completed may be further outputted to an example sentence learning layer, and an example sentence related image may be provided.

When a user selection on an icon is inputted, the control unit 1700 may control a layer corresponding to the selected icon to be outputted.

4. Reward

In a learning system 10000 according to an embodiment of the present invention may give points according to a user's activity through a learning application executed by a terminal 1000, and provide a reward function for converting given points to actually available cash.

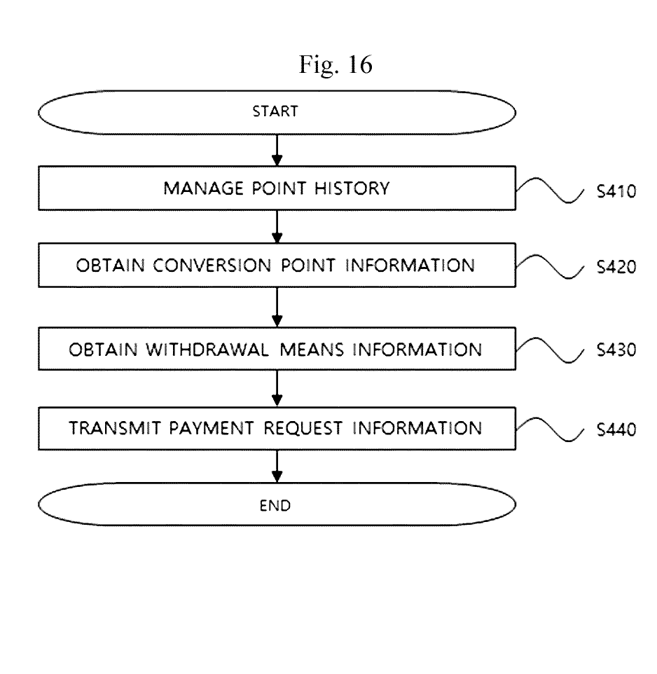

FIG. 16 is a flowchart illustrating a reward function according to an embodiment of the present invention.

Referring to FIG. 16, the reward function may include managing a point history (S410), obtaining conversion point information (S420), obtaining withdrawal means information (S430), and transmitting payment request information (S440).

The control unit 1700 may manage a point history in operation S410.

The control unit 1700 may manage a history of points generated according to a learning game, vocabulary learning, and an advertisement playback, which are executed through a learning application.

Points obtained by each corresponding activity may be predetermined in a learning game, vocabulary learning, and an advertisement playback, which are provided from a learning application.

For example, when one step of a learning game is completed newly, 20 points may be provided. For another example, when one step of vocabulary learning is completed newly, 30 points may be provided. For another example, when advertisement is played one time, 50 points may be provided.

Additionally, in the case of a learning game and vocabulary learning, points may be provided differentially according to a new completion and a re-completion of an existing completed step. For example, it may be configured that when a new step is completed in a learning game, 20 points are provided but when an existing completed step is completed again, only 5 points are provided.

Additionally, a plurality of advertisements may be pre-stored in the terminal 1000, and when a user's advertisement playback is selected, an arbitrary one of the plurality of advertisements may be played. Additionally, when an advertisement is played from a first time point to a second time point, even if a user selects the advertisement playback again, the advertisement may be played after a standby time elapses from the second time point. At this point, a standby time may be outputted to the terminal 1000 and a message for notifying that advertisement playback is unavailable during the standby time may be outputted.

Additionally, the learning application may provide various methods for obtaining points in addition to the above-mentioned learning game, vocabulary learning, and advertisement playback.

The control unit 1700 may match provided points to a user account and manage its history.

The control unit 1700 may store at least one of a basis for point occurrence (for example, the first step completion of a learning game), an occurrence time point, and occurrence points.

Additionally, the control unit 1700 may calculate and store total points (accumulated points) that is the sum of occurred points. Additionally, the control unit 1700 may perform a control to output the currently owned points (for example, owned points). Herein, the currently owned points may be points obtained by subtracting used points from accumulated points.

The control unit 1700 may transmit, to the server device 2000, point information including at least one of user information, a point history, total accumulated points, period specific accumulated points, and currently owned points.

The control unit 1700 may obtain cash information on cash assigned to a predetermined number of user accounts in the descending order of total accumulated points and the descending order of period specific accumulated points, on the basis of point information that the server device 2000 obtains from a plurality of terminals during a predetermined period.

For example, the server device 2000 may calculate the total sum of each user account specific point in one week, and assign cash to 10 user accounts having a high point sum. For a more specific example, the server device 2000 may generate cash information to assign 100 cash to a first user account having the highest points and generate cash information to assign 50 cash to second to fifth user accounts having the second to fifth highest point sums. This may vary according to a compensation policy.

For another example, the server device 2000 may calculate the total sum of each user account specific point in one week, and assign cash to 10 user accounts having a high point sum. For a more specific example, the server device 2000 may generate cash information to assign 100 cash to a first user account having the highest total accumulation points and generate cash information to assign 50 cash to second to fifth user accounts having the second to fifth highest point sums. This may vary according to a compensation policy.

Additionally, the total compensation amount may be defined with a predetermined percentage with respect to revenue (for example, advertisement revenue obtained when a user watches an advertisement). For example, the total compensation amount of this month may be defined with 40% of the total sales or total revenue of the month before last of this month. The compensation percentage may vary also according to a compensation policy.

The server device 2000 may transmit generated cash information to the terminal 1000. Additionally, the server device 2000 may transmit cash information only to the terminal 1000 logged in with a corresponding user account.

The control unit 1700 may obtain conversion point information in operation S420.

The control unit 1700 may obtain information on conversion points to be converted into cash for withdrawal among cash assigned to a user account.

The control unit 1700 may obtain information on the amount of points to be converted into cash for withdrawal among cash assigned to a user account.

The control unit 1700 may be configured to increase a predetermined amount of conversion points per user's one time selection to calculate conversion points. For example, when an increase amount per predetermined one time selection is 10, if a user makes a selection two times, 20 conversion points may be calculated.

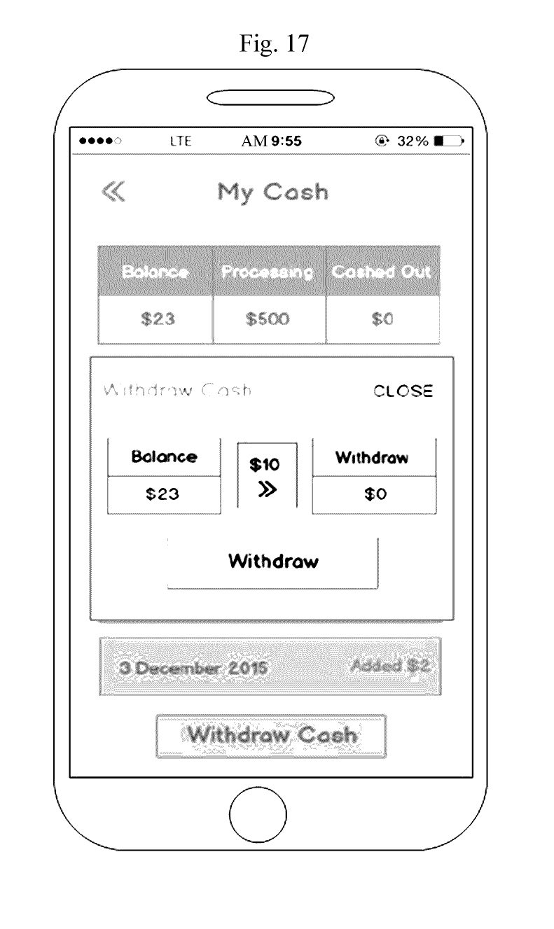

FIG. 17 is an exemplary view illustrating a conversion point calculation according to an embodiment of the present invention.

For example, the control unit 1700, as shown in FIG. 17, may output information on current cash and output a conversion point calculation result. Additionally, an object for receiving a user selection on the increase and/or decrease may be provided through the display unit 1200. Additionally, the control unit 1700 may output an object for receiving a user's final selection.

The control unit 1700 may obtain withdrawal means information in operation 5430.

The control unit 1700 may output a list for a predetermined withdrawal means. The predetermined withdrawal means, for example, may be account transfer, virtual money, and gift certificates.

The control unit 1700 may obtain a user's selection on a withdrawal means. Additionally, the control unit 1700 may obtain payment information on the selected withdrawal means. For example, when the withdrawal means is account transfer, the control unit 1700 may obtain payment information for the account transfer. For a more specific example, the control unit 1700 may obtain payment information such as a deposit target bank, an account number, and an account holder name.

The control unit 1700 may transmit payment request information in operation S440.

The control unit 1700 may transmit payment request information including at least one of conversion point information, withdrawal means information, and payment information. For example, the control unit 1700 may transmit payment request information to the server device 2000. For another example, the control unit 1700 may transmit payment request information to a bank server.

The control unit 1700 may receive a payment replay for payment request information and output a payment result message based on the received payment reply. For example, the control unit 1700 may output a message for notifying that the payment is completed. For another example, the control unit 1700 may output a message for notifying that the payment is failed.

Moreover, a user may perform a cost payment on a paid service that an operating entity provides by using cash instead of withdrawing cash. Herein, a representative example of the paid service may be a language learning program or a lecture program. Of course, the paid service is not limited thereto.

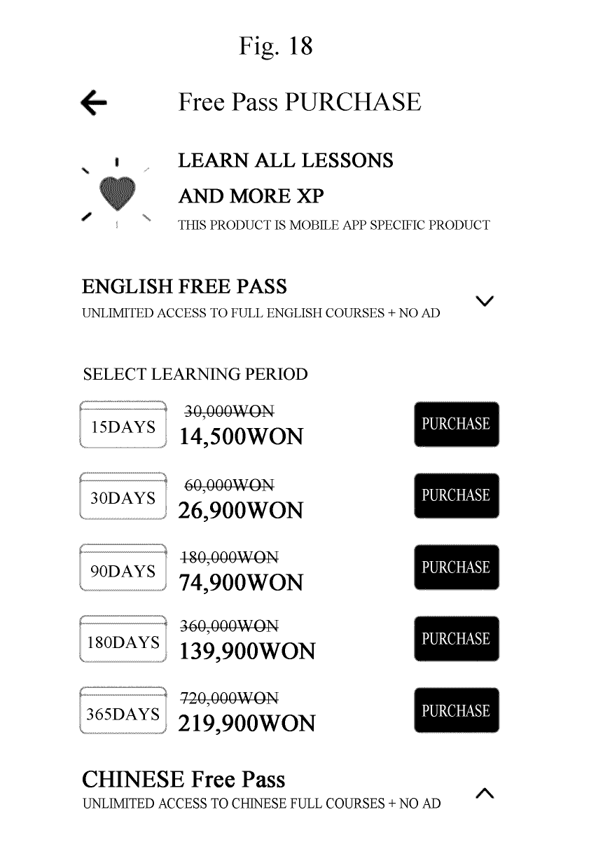

FIG. 18 is an exemplary view illustrating a paid service payment using cash according to an embodiment of the present invention.

Referring to FIG. 18, the control unit 1700 may perform a control to output information on a paid service (for example, an English lecture course in FIG. 17) and a payment amount. Herein, costs may be calculated differently depending on a service providing period. Additionally, it is not necessary that only one paid service type is suggested and it is possible to suggest a plurality of different paid services (for example, Chinese dialog lecture, English talking lecture, and English listening lecture).

A user may input a payment button on a paid service, and the terminal 1000 may receive and transmit it to the server device 2000. The server 2000 may deduct cash from user's cash in a user account by the payment amount of a paid service that a user selects and assign the authorization to use of a corresponding paid service to the user account.

The payment on a user's paid service is not limited to the above-mentioned payment method using user's cash, and various payment methods may be provided according to a selection. For example, the terminal 1000 may receive information necessary for card payment and transmit it to the server device 2000 to request the payment. For another example, the terminal 1000 may obtain information on accepted gift certificates such as culture vouchers and happy points and transmit it to the server 2000 to request the payment. In addition, a conventional payment method may be further provided for a payment for a user's paid service.

Moreover, a method of obtaining cash may include a lottery type in addition to the above-mentioned total accumulation points or period specific accumulation points.

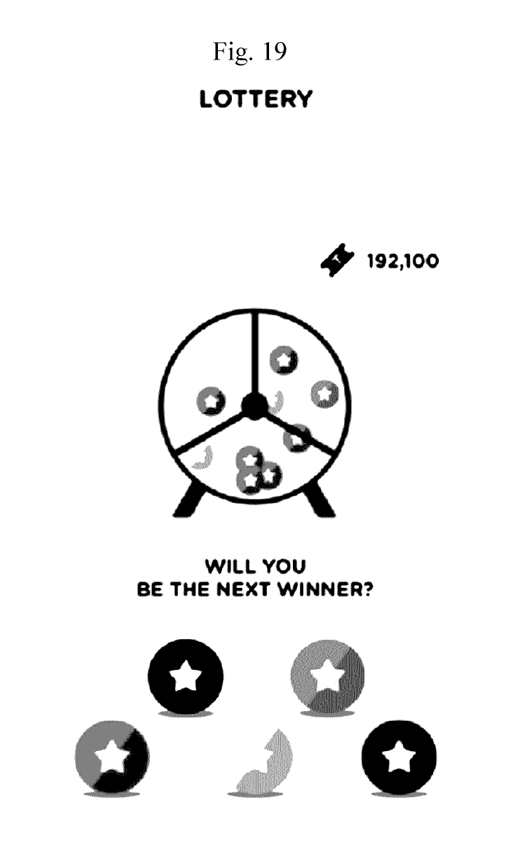

FIG. 19 is a view illustrating a lottery type cash obtaining method according to an embodiment of the present invention.

Referring to FIG. 19, the control unit 1700 may control a lottery UI to be displayed.

The user's current owned points are displayed on the lottery UI and a UI for determining the amount (all or at least part) of arbitrary points to be used for lottery in the user's current owned points may be included in the lottery UI

The control unit 1700 may receive a point amount for lottery from a user and transmit it to the server 2000, and the server 2000 may deduct the point amount used from a user account.

Additionally, the amount of points that other users bet for lottery and the amount that a user is to use at the current time point or a lottery winning percentage for the amount used before may be displayed on the lottery UI.

Lottery may be performed at the same period interval as the draw according to the amount of period specific accumulation points. That is, the lottery winning result and the draw result may be determined in the same period.

If a user wins lottery, cash may be provided to the winning user.

For example, 100 people may win lottery and the same or different cash may be given to the 100 winners. The number of winners or a cash payment amount may be selected appropriately according to a compensation policy of an operating entity.

The server device 2000 may obtain information on a lottery point amount to use according to a user account, from the terminals 1000. Additionally, the server device 2000 may set each account specific share in lottery according to the sum of total lottery points to use and each account specific lottery points to use, which are obtained from the terminals 1000. For example, when the total lottery points to use are 1000 points and a first user account uses 100 points, the first user account has a 10% share and as a result, the winning percentage of the first user may be 10%. Accordingly, the winning percentage of lottery may vary according to points that each user account uses for lottery.

Moreover, the winning for lottery may include a method similar to the draw according to point amounts. For example, the total cash amount to be distributed to users through lottery may be defined with a specific percentage proportional to the total revenue or total sales of an operating entity.

According to an embodiment of the present invention, as points obtained through a learning application are withdrawn as cash available in real life, it is possible for a user to motivate learning.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A learning application controlling method, as a method for providing points obtained through a learning application as cash available in real life, the method comprising:
managing a point history to store point information that calculates points, which are obtained by performing a predetermined process provided from the learning application by each user account and/or transmit the point information to a server device;
obtaining cash information assigned to a predetermined number of user accounts in a descending point acquisition order of total points based on the point information that the server device obtains from a plurality of terminals, from the server device;
obtaining conversion point information on cash to be withdrawn in cash assigned to the user account based on the cash information;
obtaining a withdrawal means for the withdrawal and payment information; and
transmitting payment request information based on the conversion point information, the withdrawal means, and the payment information.

2. The method of claim 1, wherein the predetermined process is at least one of a learning game mode, a vocabulary learning mode, and an advertisement playback.

3. The method of claim 2, wherein a learning game GUI is provided in the learning game mode, and a plurality of learning game specific category objects are provided to the learning game GUI.

4. The method of claim 3, wherein the learning game specific category object is linked to a game step layer where a game step object for game steps belonging to the learning game category is provided.

5. The method of claim 4, wherein a game step object provided to a game step layer is linked to a learning game corresponding to the game step.

6. The method of claim 5, wherein when a combination of a spelling of objects sequentially selected through a drag input and/or continuous touch matches a spelling of a predetermined word, the game determines that a corresponding step is completed.

7. The method of claim 5, wherein when a help request object is provided and selected, the game requests a predetermined SNS to write a help request message based on an image on the game and a step of the game through the predetermined SNS.

8. The method of claim 2, wherein the vocabulary learning mode is at least one of a first mode for providing a category specific word and a comment for the word, a second mode for playing a predetermined video; and a third mode for providing a predetermined example sentence.

9. The method of claim 2, wherein the managing of the point history comprises calculating points provided according to a step completed in the learning game mode.

10. The method of claim 2, wherein the managing of the point history comprises calculating points provided according to the number of playing the advertisement.

11. The method of claim 2, wherein the managing of the point history comprises calculating points provided according to a step completed in the vocabulary learning mode.

12. A non-transitory recording medium having recorded thereon a program for causing a processing system to perform a method for providing points obtained through a learning application as cash available in real life, wherein the method includes:
managing a point history to store point information that calculates points, which are obtained by performing a predetermined process provided from the learning application by each user account and/or transmit the point information to a server device;
obtaining cash information assigned to a predetermined number of user accounts in a descending point acquisition order of total points based on the point information that the server device obtains from a plurality of terminals, from the server device;
obtaining conversion point information on cash to be withdrawn in cash assigned to the user account based on the cash information;
obtaining a withdrawal means for the withdrawal and payment information; and
transmitting payment request information based on the conversion point information, the withdrawal means, and the payment information.

13. The non-transitory recording medium of claim 12, wherein the predetermined process is at least one of a learning game mode, a vocabulary learning mode, and an advertisement playback.

14. The non-transitory recording medium of claim 13, wherein a learning game GUI is provided in the learning game mode, and a plurality of learning game specific category objects are provided to the learning game GUI.

15. The non-transitory recording medium of claim 14, wherein the learning game specific category object is linked to a game step layer where a game step object for game steps belonging to the learning game category is provided.

16. The non-transitory recording medium of claim 15, wherein a game step object provided to a game step layer is linked to a learning game corresponding to the game step.

17. The non-transitory recording medium of claim 16, wherein when a combination of a spelling of objects sequentially selected through a drag input and/or continuous touch matches a spelling of a predetermined word, the game determines that a corresponding step is completed.

18. The non-transitory recording medium of claim 16, wherein when a help request object is provided and selected, the game requests a predetermined SNS to write a help request message based on an image on the game and a step of the game through the predetermined SNS.

19. The non-transitory recording medium of claim 13, wherein the vocabulary learning mode is at least one of a first mode for providing a category specific word and a comment for the word, a second mode for playing a predetermined video; and a third mode for providing a predetermined example sentence.

20. The non-transitory recording medium of claim 13, wherein the managing of the point history comprises calculating points provided according to a step completed in the learning game mode.

21. The non-transitory recording medium of claim 13, wherein the managing of the point history comprises calculating points provided according to the number of playing the advertisement.

22. The non-transitory recording medium of claim 13, wherein the managing of the point history comprises calculating points provided according to a step completed in the vocabulary learning mode.
